(19) United States
(12) Patent Application Publication
(10) Pub. No.: US 2020/0410591 A1
(43) Pub. Date: Dec. 31, 2020

(54) COMPUTERIZED ASSET TRANSFER AND TITLE RECORDAL ON DISTRIBUTED LEDGERS

(71) Applicant: MURABAHA INC., Toronto (CA)

(72) Inventors: Mohamad Mohtaz SAWWAF, Toronto (CA); Sam HOLAKOOZADEH, Toronto (CA); Mustafa Hazem ELKALZA, Mississauga (CA)

(21) Appl. No.: 16/915,591

(22) Filed: Jun. 29, 2020

Related U.S. Application Data
(60) Provisional application No. 62/868,025, filed on Jun. 28, 2019.

(51) Int. Cl. G06Q 40/04; G06Q 40/02; G06Q 50/16; G06Q 40/08; G06Q 20/10; G06F 16/23; G06F 16/27

(52) U.S. Cl. CPC G06Q 40/04; G06Q 40/025; G06Q 50/167; G06F 16/27; G06Q 20/108; G06F 16/2379; G06Q 40/08

(57) ABSTRACT

A computer system for facilitating transactions includes a buyer computing device to record an indication of a request from a buyer device to purchase an asset and a seller computing device to record an indication of acceptance from a seller device to sell the asset in accordance with the request for an agreed price. The system further includes a sponsor computing device, an operator of which is to establish a holding entity through which ownership of the asset is transferred from an operator of the seller device to an operator of the buyer device through completion of a financing term in which the operator of the buyer device effects repayment of a loan price to the operator of the sponsor computing device. The sponsor computing device is further to record aspects of the transaction on a distributed ledger.

### FIELD

The present invention relates generally to information processing, and in particular to the processing of information to facilitate an asset transfer.

### BACKGROUND

A distributed ledger is a decentralized store of digital information which is maintained by nodes of a peer-to-peer network. The nodes of the peer-to-peer network store the entirety or a portion of the distributed ledger and update the information stored thereon to reflect a shared set of facts. An update to the information made at one or more nodes is propagated to other nodes if it can be verified that the update is legitimate.

An update to the information stored on the distributed ledger may be characterized as a transaction. Transactions may reflect real-world transfer of assets, such as the transfer of a real estate property.

### SUMMARY

According to an aspect of the specification, a computer system for facilitating transactions between transaction participant nodes connected over a peer-to-peer distributed ledger network includes a buyer node, a seller node, and a funder node. The buyer node is to record, on a distributed ledger, an indication of a request from a buyer device to purchase an asset. The seller node to record, on the distributed ledger, an indication of acceptance from a seller device to sell the asset in accordance with the request for an agreed price. The funder node is controlled by an operator of the funder node. The operator of the funder node is to establish a holding entity through which ownership of the asset is transferred from an operator of the seller device to an operator of the buyer device through completion of a financing term in which the operator of the buyer device effects repayment of a loan price to the operator of the funder node, the loan price greater than the agreed price, the holding entity holding title to the asset throughout a duration of the financing term. The funder node is to record, on the distributed ledger, establishment of the holding entity and securitization of repayment of the loan price via a mortgage against the asset in favor of the operator of the funder node until completion of the financing term.

According to another aspect of the specification, a funder node connected over a peer-to-peer distributed ledger network to transaction participant nodes includes a communication interface and a controller. The communication interface is to communicate with a buyer node and a seller node over the peer-to-peer distributed ledger network, an operator of the seller node in acceptance to sell an asset to an operator of the buyer node for an agreed price. The controller is to record, on a distributed ledger establishment of a holding entity, by an operator of the funder node, through which ownership of the asset is to be effected through completion of a financing term for repayment of a loan price by the operator of the buyer node, the loan price greater than the agreed price, the holding entity holding title to the asset during the financing term. The controller is further to record, on the distributed ledger, securitization of repayment of the loan price via a mortgage against the asset in favor of the operator of the funder node until completion of the financing term.

According to yet another aspect of the specification, a computerized method for executing sale of an asset from an operator of a seller device to an operator of a buyer device involves indicating an asset to be purchased by the operator of the buyer device. The method further involves obtaining acceptance that the operator of the seller device is to sell the asset to the operator of the buyer device for an agreed price, payment for the asset being funded by a funder (also termed as a sponsor) of a mortgage. The method further involves establishing a holding entity through which ownership of the asset is transferred from the operator of the seller device to the operator of the buyer device through completion of a financing term for repayment of a loan price by the operator of the buyer device, the loan price greater than the agreed price, the holding entity holding title to the asset during the financing term. The method further involves acquiring title to the asset by the holding entity and acquiring beneficial ownership of the asset by the funder of the mortgage, for the agreed price, selling the beneficial ownership of the asset from the funder of the mortgage to the operator of the buyer device for the agreed price, and selling control of the holding entity from the funder of the mortgage to the operator of the buyer device for a control price, the control price and the agreed price together amounting to the loan price. The method further involves securitizing repayment of the loan price via a mortgage against the asset in favor of the funder of the mortgage until completion of the financing term.

### BRIEF DESCRIPTION OF THE DRAWINGS

FIG. 1 is a schematic diagram of an example computer system for facilitating transactions between transaction participant nodes connected over a peer-to-peer distributed ledger network.

FIG. 2 is a block diagram of an example node in a peer-to-peer distributed ledger network.

FIG. 3 is a sequence diagram of an example process for asset transfer and title recordal on a distributed ledger.

FIG. 4 is a flowchart of an example method for computerized asset transfer and title recordal.

FIG. 5 is a flowchart of an example method for asset transfer and title recordal.

FIG. 6 is a flowchart of another example method for asset transfer and title recordal.

FIG. 7 is a schematic diagram of another example computer system for facilitating transactions between transaction participant nodes connected over a peer-to-peer distributed ledger network, the system including investor devices and associated investor nodes connected over the network.

FIG. 8 is a schematic diagram of yet another example computer system for facilitating transactions between transaction participant nodes connected over a peer-to-peer distributed ledger network, the system including an off-ledger entity registry and off-ledger asset registry.

### DETAILED DESCRIPTION

The use of computerized systems to facilitate the transfer of assets is becoming increasingly widespread. Computerized systems can bring the benefits of convenient automation, increased transaction speed, and more reliable long-term record-keeping, to several asset transfer processes which have predominantly been paper-driven.

An example of one such process in which the computerization of an asset transfer process may be particularly beneficial is in the transfer of real estate assets. Real estate transactions are largely still heavily paper-driven, and typically involve the review and execution of several agreements between several different parties, including an agreement of purchase and sale between a buyer and a seller, a financing agreement between the buyer and a financial service provider, and agreements with legal counsel. Fraud related to the transfer of real estate assets remains a significant concern.

The transfer of real estate assets is also typically subject to one or more regulatory frameworks which restricts the manner in which real estate transactions may be conducted. Any deviation from conventional purchasing arrangements and financing arrangements may result in severe fines or other penalties for the parties involved.

Financial arrangements to provide funding for real estate transactions are particularly restricted. Regulatory frameworks are typically designed to suit conventional mortgage arrangements in which a prospective buyer of a property enters into a mortgage to purchase the property, and repays the loan to the financier, with interest, to a financial service provider, with the interest rate being periodically subject to renewal. Since the interest rate is subject to renewal, and since market interest rates fluctuate with the market, such financial arrangements have an inherent element of instability. Further, though subject to legal restriction, such arrangements are still fraught with fraud and misuse. Thus, the majority of real estate financing is conducted, on penalty of severe fines, according to an inherently restrictive and unstable financial arrangement. The system is entrenched by existing regulatory framework and by a reliance on paper-driven systems. It is desirable to have a more flexible, and secure, system of asset transfer which enables alternative modes of asset transfer and financial arrangements.

The present specification describes a system for facilitating asset transfer, including the transfer of real estate assets and other asset types, which enables alternative modes of transacting and financing. The system described herein provides the benefits of convenient automation, increased transacting speed, and more reliable long-term record-keeping, and security, among other benefits, to systems of asset transfer.

The present specification improves upon a traditional distributed ledger by including a plurality of nodes that cooperate with each other to enable more stability, security, and flexibility, or for avoiding the imposition of restrictive regulation.

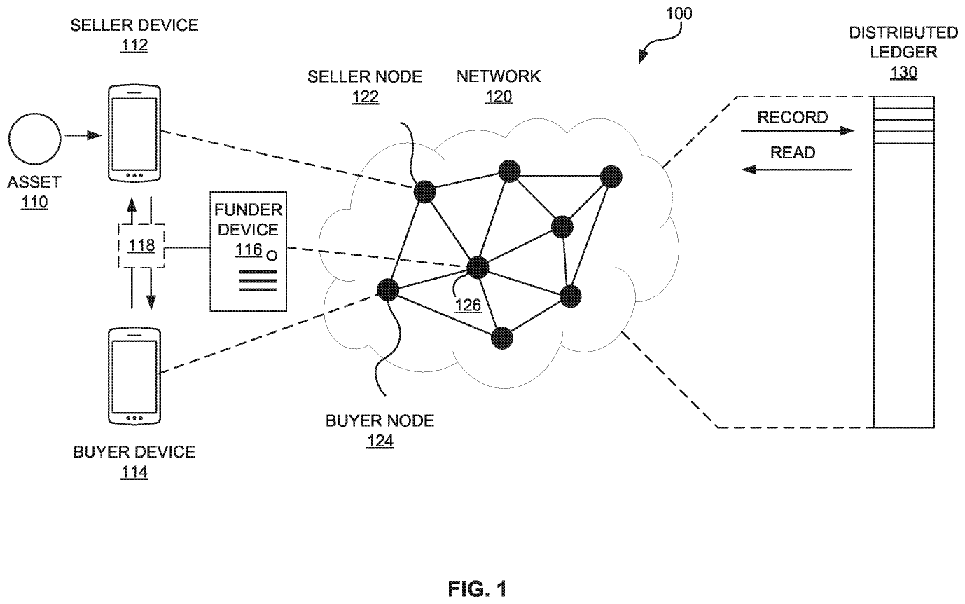

FIG. 1 is a schematic diagram of one such example computerized system for facilitating asset transfer. FIG. 1 describes an example computerized system 100 for facilitating transactions between transaction participant nodes connected over a peer-to-peer distributed ledger network 120.

The system 100 includes an asset 110 to be transferred from an operator of a seller device 112 to an operator of a buyer device 114. The seller device 112 and buyer device 114 may be termed transaction participants. The asset 110 may be a real estate property or other asset type.

The system 100 further includes a funder device 116 (also referred to as a funder computer 116, or as sponsor computer 116) to provide funding to facilitate the transaction between the seller device 112 and the buyer device 114. In particular, the funder device 116 facilitates the transaction by the operator thereof providing financing to the operator of the buyer device 114. The operator of the funder device 116 further facilitates transfer of the asset through the establishment of a holding entity 118, discussed in greater detail below. The seller device 112, buyer device 114, and funder device 116 may be in communication via one or more computer or telecommunication networks, not shown.

The seller device 112, buyer device 114, and funder device 116, are computing devices having processing, storage, and communication means. The seller device 112 and buyer device 114 may be mobile devices, such as smart phones, which are associated with unique identifiers to uniquely identify the operators thereof. The funder device 116 may similarly be a mobile device, or in other examples, a server computer capable of facilitating a large number of transactions.

Certain communications between the seller device 112, buyer device 114, and funder device 116 are mirrored on the peer-to-peer distributed ledger network 120, referred to hereinafter as the network 120. Connected over the network 120 are a seller node 122, buyer node 124, and funder node 126 (also termed as seller computing device 122, buyer computing device 124 and funder computing device 126). Funder node 126 may also be referred to herein as sponsor computing device 126. The seller node 122 and buyer node 124 may be termed transaction participant nodes, and are associated with the seller device 112 and buyer device 114, respectively, and are controlled by the respective devices via a distributed software application. The funder node 126 may be termed a transaction facilitator node, and is associated with the funder device 116, and is controlled by the funder device 116 via a distributed software application. Such a distributed software application may be used by the devices 112, 114, 116, to control the nodes 122, 124, 126, respectively, to read from and write to a distributed ledger 130.

In operation, the buyer node 124 is to record, on the distributed ledger 130, an indication of a request from the buyer device 114 to purchase the asset 110. Accordingly, the seller node 122 is to record, on the distributed ledger 130, an indication of acceptance from the seller device 112 to sell the asset 110 in accordance with the request for an agreed price. The agreed price represents the price for which the operator of the seller device 112 agrees to sell the asset 110 to the operator of the buyer device 114. In some examples, the request and acceptance may be communicated via the one or more computer or telecommunications networks, not shown. In other examples, the request and acceptance may be recorded on the distributed ledger 130.

The funder device 116, and thus the funder node 126, are controlled by an operator, hereinafter referred to as the operator of the funder node 126. The operator of the funder node 126 is to establish the holding entity 118, through which ownership of the asset 110 is transferred from the operator of the seller device 112 to the operator of the buyer device 114 through completion of a financing term in which the operator of the buyer device 114 effects repayment of a loan price to the operator of the funder node 126. That is, the operator of the buyer device 114 repays the operator of the funder node 126 for financing provided for the purchase of the asset 110. The loan price is greater than the agreed price, and thus the operator of the funder node 126 may make a profit by facilitating the transaction.

The holding entity 118 holds title to the asset 110 throughout a duration of the financing term. By the holding entity 118 retaining title to the asset 110, greater flexibility in the structure of the financing term may be arranged, and legal regulatory restrictions which would otherwise penalize the transaction participants may be avoided, as will be seen in greater detail below.

The funder node 126 is further to record, on the distributed ledger 130, establishment of the holding entity 118, and securitization of repayment of the loan price via a mortgage against the asset 110 in favor of the operator of the funder node 126 until completion of the financing term. The transaction is thus made transparent and secure on the distributed ledger 130 and its details may be verified by other nodes on the network 120.

Certain information on the distributed ledger 130 may be restricted to viewing by certain parties. For example, the details of a transaction may be readable only by the transaction participants themselves, regulatory bodies, and other authorized parties.

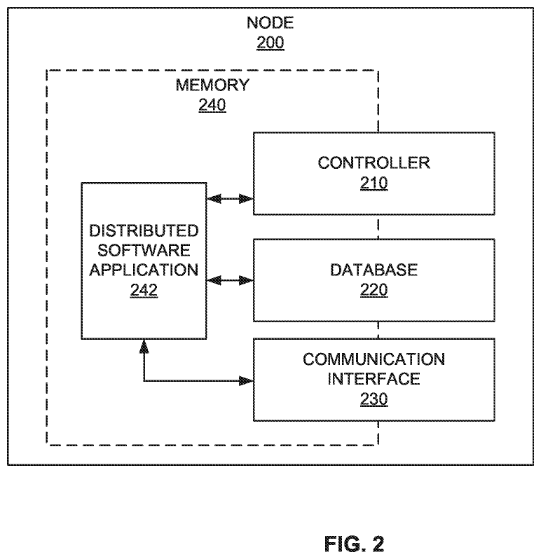

FIG. 2 is a block diagram of an example node 200 of a peer-to-peer distributed ledger network. The node 200 may be similar to the seller node 122, buyer node 124, funder node 126, or another node of the network 120, and thus for further description of the node 200, reference may be had to the description of such elements in FIG. 1.

The node 200 includes a controller 210, database 220, communication interface 230, and memory 240. The controller 210 may include any quantity and combination of a processor, a central processing unit (CPU), a microprocessor, a microcontroller, a field-programmable gate array (FPGA), and similar. The database 220 may include non-volatile storage on which any kind of database, such as one or more SQL databases, for storing portions of a distributed ledger, may be maintained. The communication interface 230 includes programming logic enabling the node 200 to communicate over a peer-to-peer distributed ledger network, is configured for bidirectional data communications through the network, and accordingly can include a network adaptor and driver suitable for the type of network. The controller 210, database 220, communication interface 230, and memory 240, cooperate to implement services such as identity services, key management, scheduling, messaging, a network map cache, state manager, other custom services and the like.

The memory 240 may include a non-transitory computer-readable medium that may include volatile storage, such as random-access memory (RAM) or similar, and may include non-volatile storage, such as a hard drive, flash memory, and similar. Memory 240 may also include non-transitory machine-readable instructions, such as a software application, to enable the node 200 to communicate with other nodes over a peer-to-peer network and to interface with a distributed ledger. Such instructions may be installed at the node level across the node 200 and other nodes. In other words, the node 200 may execute a distributed software application 242. Such a distributed software application 242 may include components to implement any of the methods described herein, or any portions thereof, including requesting purchase of an asset, accepting a request to purchase an asset, recording to the distributed ledger, and reading from the distributed ledger. The distributed software application 242 may further include components to generate a contract for the sale of the asset, a contract for financing and repayment, and other contracts to fulfill any of the methods described herein. Since entries on the distributed leger are verified by the nodes of the distributed ledger network as the information is propagated throughout the network, such contracts are secured, and made verifiable, by being recorded on the distributed ledger.

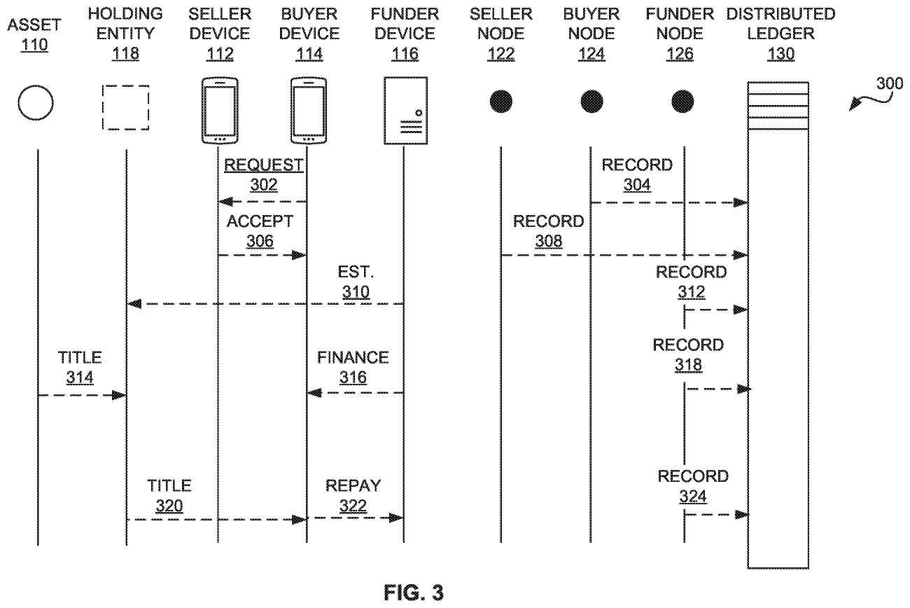

FIG. 3 is a sequence diagram of an example process 300 for asset transfer and title recordal on a distributed ledger. For convenience, reference is had to the elements of FIG. 1, namely the asset 110, seller device 112, buyer device 114, funder device 116, holding entity 118, seller node 122, buyer node 124, funder node 126, and distributed ledger 130. However, it is to be understood that this is not limiting, and that the process 300 may take place with other devices, nodes, and other elements.

First, the buyer device 114 transmits a request 302 to the seller device 112 for the purchase of the asset 110. On the distributed ledger 130, the request 302 is recorded at 304. If accepted, the seller device 112 then transmits acceptance 308 to the buyer device 114. At 308, the acceptance is recorded on the distributed ledger 130. It is to be understood that these actions can be modified or reversed, that is, the seller device 112 may make a request to the buyer device 114, and vice versa, provided that an agreement to transfer the asset 110 for an agreed price is reached.

Once an agreement to transfer the asset 110 is reached, at 310, the funder device 116, or an operator thereof, establishes the holding entity 118. Establishment of the holding entity 118 is recorded on the distributed ledger 130 at 312. The holding entity 118 facilitates transfer of the asset 110 according to a financial arrangement which may avoid penalization according to existing regulatory frameworks.

At 314, title to the asset 110 passes to the holding entity 118, and the funding device 116 provides financing at 316 to the buyer device 114. At 318, the passing of title and the provision of financing is recorded on the distributed ledger 130. Title to the asset 110 remains in the holding entity 118 for the duration of the financial arrangement. That is, where the operator of the buyer device 114 is to repay the operator of the funder device 116 a loan price over a particular duration, title to the asset 110 remains with the holding entity 118 during the repayment term. As will be seen below, control of the holding entity 118 may change at the beginning of the repayment term, during the repayment term, or at the end of the repayment term, as necessary, in order to give effect to the financial arrangement.

Upon completion of the financing term when the loan price is repaid at 332, title to the asset 110 passes to the buyer device 114 at 320. Passing of title and completion of repayment is recorded at the distributed ledger 130 at 324.

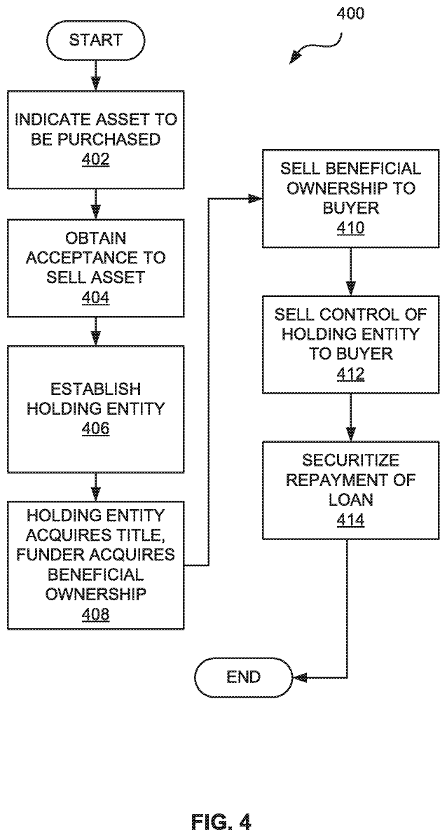

FIG. 4 is a flowchart of an example method 400 for computerized asset transfer and title recordal. The method 400 is one example of a method for asset transfer and title recordal which may be implemented by one of the computerized systems described herein, such as system 100 of FIG. 1, to enable greater flexibility in the structure of transacting and financing to purchase the asset. It is to be understood that the method 400 may be implemented using other systems

At block 402, an asset to be purchased by the operator of a buyer device is indicated. At block 404, acceptance that the operator of the seller device is to sell the asset to the operator of the buyer device for an agreed price is obtained. Payment for the asset is funded by via a mortgage by a funder of the mortgage.

At block 406, a holding entity through which ownership of the asset is transferred from the operator of the seller device to the operator of the buyer device is established. Ownership is transferred through completion of a financing term for repayment of a loan price by the operator of the buyer device, the loan price greater than the agreed price, the holding entity holding title to the asset during the financing term.

Blocks 408 through 412 describe a particular set of transactions that facilitate transfer of ownership in the asset to the buyer. At block 408, title to the asset is acquired by the holding entity, and beneficial ownership of the asset is acquired, by the funder of the mortgage, for the agreed price. At block 410, the beneficial ownership of the asset is sold from the funder of the mortgage to the operator of the buyer device for the agreed price. At block 412, control of the holding entity is sold from the funder of the mortgage to the operator of the buyer device for a control price. The control price and the agreed price together amount to the loan price.

At block 414, repayment of the loan price is securitized via a mortgage against the asset in favor of the funder of the mortgage until completion of the financing term. Thus, the buyer has registered title to the property, and the funder has a mortgage secured against the property.

The financial arrangement described above may be especially desirable for parties wishing to engage in a financing arrangement which does not involve the payment of interest, but in which it is nevertheless desirable for the funder to make a profit on having provided a financial service. Financial arrangements which do not involve the payment of interest at a rate, which typically fluctuates with the market, is an inherently more stable form of financing. Thus, the method 400 therefore provides an alternative to conventional mortgage financing which is more financially stable. Further, financial arrangements which do not involve the payment of interest may be particularly attractive to followers of religious beliefs that forbid the charging of interest, including adherents to Islamic law, and thus, the method 400 further provides a religiously-compliant financial arrangement which is competitive with conventional mortgage arrangements.

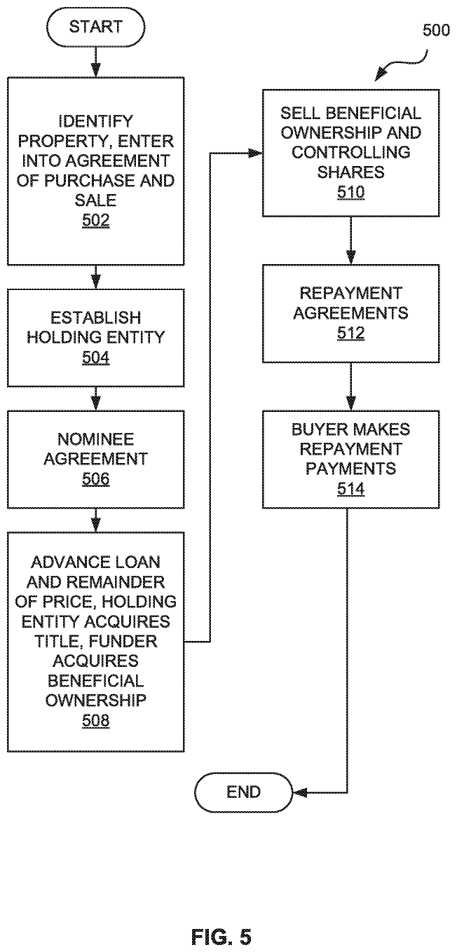

FIG. 5 is a flowchart of an example method 500 for asset transfer and title recordal. The method 500 is one example of a method for asset transfer and title recordal which may be implemented by one of the computerized systems described herein which use a distributed ledger, such as system 100 of FIG. 1, to enable greater flexibility in the structure of financing to purchase the asset. In other examples, the method 500 may be performed without the use of distributed ledgers, facilitated by conventional computing infrastructure. Further, the method 500 is to be understood as one particular implementation of the method 400 of FIG. 4 which avoids the application of penalties according to existing legal regulatory regimes in one jurisdiction, namely the province of Ontario, Canada, and in particular to facilitate the transfer of a real estate property. It is to be understood that the method 500 may be implemented using other systems. Further, it is to be understood that the method 500 may be modified to avoid the application of penalties according to the legal regulatory regimes of another jurisdiction, or for other asset types.

At block 502, a buyer (the “Buyer”) identifies a residential property (the “Property”) to be purchased and enters into an agreement of purchase and sale with a vendor of the Property (the “Seller”) to purchase the Property for the lowest price that both the Seller and the Buyer re willing to accept (the “Agreed Price”). The agreement of purchase and sale includes the right of the Buyer to direct title to the Property to a Holding Entity on a Closing Date.

At block 504, a funder (the “Funder”) forms a nominee corporation (the “Holding Entity”) and names a representative of the Funder as the sole officer and director of the Holding Entity.

At block 506, a nominee agreement is entered into between the Funder and the Holding Entity which, according to its terms, cannot be terminated by the beneficial owner without written consent of the Holding Entity at its sole discretion.

At block 508, on the Closing Date, the Funder advances net Loan proceeds to the Buyer's counsel and the Buyer contributes the remainder of the Agreed Price and other closing costs, and the, the Holding Entity acquires registered title to the Property, and the Funder acquires beneficial ownership of the Property for the Agreed Price.

At block 510, the Funder then sells beneficial ownership of the Property to the Buyer for a price equal to amount of the Loan in accordance with a beneficial transfer agreement (the “Beneficial Transfer Agreement”). Then, a moment later and while the sale transaction remains in escrow, the Funder sells all of the shares of the Holding Entity (the “Shares”) to the Buyer for an amount (the “Control Price”) that is equal to the total amount of interest that a conventional lender would receive on an interest-bearing loan in the amount of the Loan in accordance with a share transfer agreement (the “Share Transfer Agreement”) and the representative of the Funder resigns as the sole officer and director of the Holding Entity and the Buyer is appointed as the officer and director of the Holding Entity.

At block 512, pursuant to the terms of the Beneficial Transfer Agreement and the Share Transfer Agreement, respectively, the Buyer agrees to pay the amount of the Loan and the entirety of the Control Price over the term of the Loan in equal monthly installments as set out above in accordance with the terms of such agreements. The obligation of the Buyer to pay the Loan and the Control price are secured by, inter alia, a first ranking mortgage on the Property incorporating a schedule of additional provisions (the “Mortgage”) and by a pledge of the Shares in accordance with a securities pledge agreement (the “Share Pledge Agreement”), both in favor of the Funder. The Loan is non-recourse to the Buyer.

At block 514, the Buyer makes fixed monthly payments on the Loan and the Control Price to the Funder as set out in a Commitment Letter and in the Mortgage. As of block 518, a financial arrangement is established, in which the Buyer holds registered title to the Property, but the Funder holds a mortgage and a Pledge against the Property which allows for enforcement of the mortgage or maturity of the mortgage, as the case may be. Further, the transaction has been arranged in a manner which does not result in a duplication of transfer tax, or in the basis of imposition for transfer tax being inflated, and does not require the funder to charge sales tax on the “profit” of the financial service, and does not involve the charging of a fee which would deemed to be interest by religious groups, and which does not involve the charging of an interest fee which fluctuates with market rates.

If the Buyer fails to make payments and fails to remedy such default after having been given a reasonable opportunity to cure the default, the Funder can realize on the Mortgage and on the Share Pledge Agreement. I

If the Buyer pays the Loan and the Control Price in full by a Maturity Date or otherwise in accordance with the terms thereof, the Funder releases the Mortgage and Share Pledge Agreement.

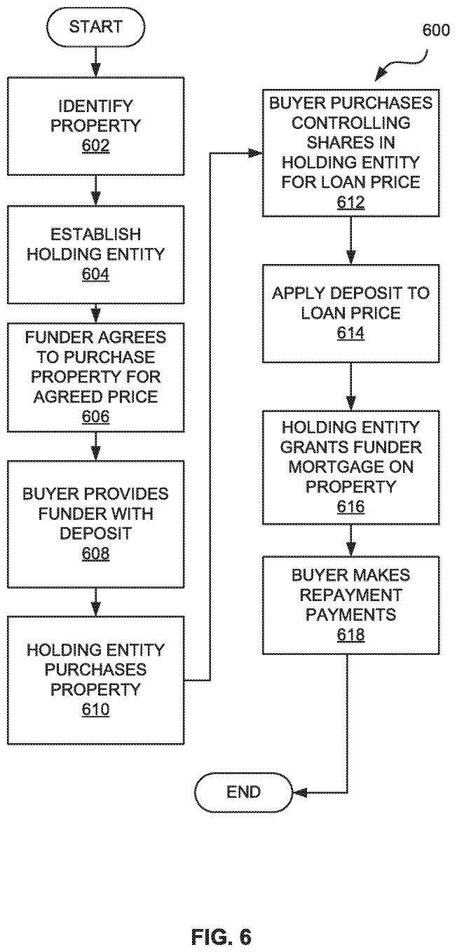

FIG. 6 is a flowchart of yet another example method 600 for asset transfer and title recordal. The method 600 is one example of a method for asset transfer and title recordal which may be implemented by one of the computerized systems described herein which use a distributed ledger, such as system 100 of FIG. 1, to enable greater flexibility in the structure of financing to purchase the asset. In other examples, the method 600 may be performed without the use of distributed ledgers, facilitated by conventional computing infrastructure. Further, the method 600 is to be understood as one particular implementation of the method 400 of FIG. 4 which avoids the application of penalties according to existing legal regulatory regimes in one jurisdiction, namely the province of Quebec, Canada, and in particular to facilitate the transfer of a real estate property. It is to be understood that the method 600 may be implemented using other systems. Further, it is to be understood that the method 600 may be modified to avoid the application of penalties according to the legal regulatory regimes of another jurisdiction, or for other asset types.

At block 602, a buyer (the “Buyer”) identifies a residential property that is not a new construction (the “Property”) that it wants to purchase.

At block 604, a funder (the “Funder”) forms a new corporation of which it is a sole shareholder (the “Holding Entity”).

At block 606, the Funder enters into an agreement of purchase and sale with a third party seller (the “Seller”) to acquire the Property at a future date for a price (the “Agreed Price”).

At block 608, the Buyer gives the Funder a deposit equal to 20% of the Agreed Price (the “Deposit”).

At block 610, the Funder causes the Holding Entity to purchase the Property from the Seller for the Agreed Price. Transfer duties on this purchase will be charged to the Holding Entity sometime after closing and the Buyer will be responsible for funding them to the Holding Entity.

At block 612, the Buyer purchases the shares of the Holding Entity from the Funder for a price (the “Loan Price”) equal to the aggregate of (a) the Agreed Price and (b) an amount equal to what a conventional lender would receive as interest over a maximum 25 year term on a loan in a principal amount equal to 80% of the Agreed Price.

At block 614, the Deposit is immediately applied to the Loan Price and the Buyer agrees to pay the balance of the Loan Price to the Funder, without interest, in equal monthly installments over a maximum 25 year term.

At block 616, the Holding Entity grants the Funder a mortgage on the Property to secure repayment by the Buyer of the balance of the Loan Price. Thus, the Buyer is made the registered and beneficial owner of the Property, and the Funder holds a mortgage against the property. Further, the transaction has been arranged in a manner which does not result in a duplication of transfer tax, or in the basis of imposition for transfer tax being inflated, and does not require the funder to charge sales tax on the “profit” of the financial service, and does not involve the charging of a fee which would deemed to be interest by religious groups, and which does not involve the charging of an interest fee which fluctuates with market rates.

At block 618, the Buyer makes repayment payments to the Funder in accordance with the mortgage.

After 24 months after its acquisition of the shares of the Holding Entity, the Buyer can transfer the Property from the Holding Entity to itself without triggering additional transfer duties. From and after the transfer, any capital gains from the sale of the Property will be tax exempt. The mortgage will continue to charge the Property.

If the Buyer fails to make a payment and does not remedy such default, the Funder will realize on the mortgage and any amount that the Funder receives from such realization in excess of the outstanding amount of the Loan Price may be remitted to the Buyer, subject to complying with statutory notice periods and to the Buyer's legal rights to require that the Funder exercise a remedy other than taking in payment or foreclosure.

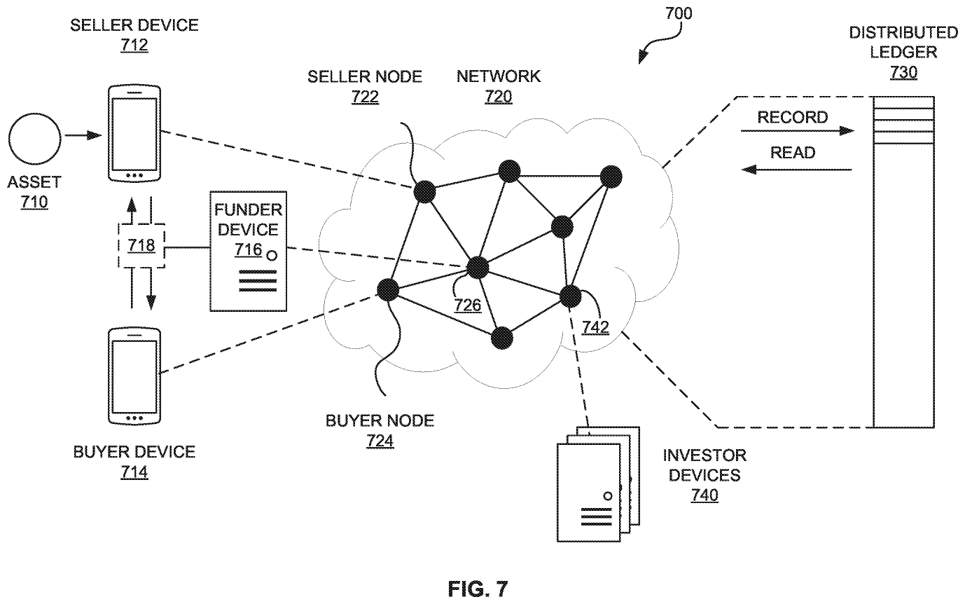

FIG. 7 is a schematic diagram of another example computer system 700 for facilitating transactions between transaction participant nodes connected over a peer-to-peer distributed ledger network. The system 700 is similar to the system 100 of FIG. 1, and thus includes an asset 710, seller device 712, buyer device 714, funder device 716, holding entity 718, network 720, seller node 722, buyer node 724, funder node 726, and distributed ledger 730. For further description of these elements, reference may be had to the description of the system 100 of FIG. 1.

In contrast to the system 100 of FIG. 1, the system 700 of FIG. 7 includes investor devices 740 associated with investor nodes 742. The investor devices 740 are in communication with the funder device 716 and provide funding for the loans provided by the funder device 716. The investor nodes 742 interact over the network 720 on behalf of the investor nodes 742, reading and writing to the distributed ledger 730 to engage in investment agreements with the operator of the funder device 716.

With investors providing funding to facilitate the transaction of the transfer of the asset 710, the system 100 provides an opportunity for additional parties to engage in the alternative financial arrangements that may be implemented using the system 700. For example, since the system 700 is used to implement a method for facilitating transfer of an asset via a financial arrangement that does not involve the payment of interest, investors who are interested in avoiding financial transactions which involve the payment of interest may support such alternative financial arrangements. As another example, since the system 700 involves the provision of funding by a funder who takes on significant risk in the financial arrangement, investors who are interested in supporting funders which have a significant financial stake in the transaction may support such alternative financial arrangements. Thus, the system 700 provides not only a vehicle with which alternative funding arrangements may be provided, but also provides investments for like-minded investors to invest in. Further, the system 700 provides the basis for the development of alternative financial instruments for like-minded investors to invest in.

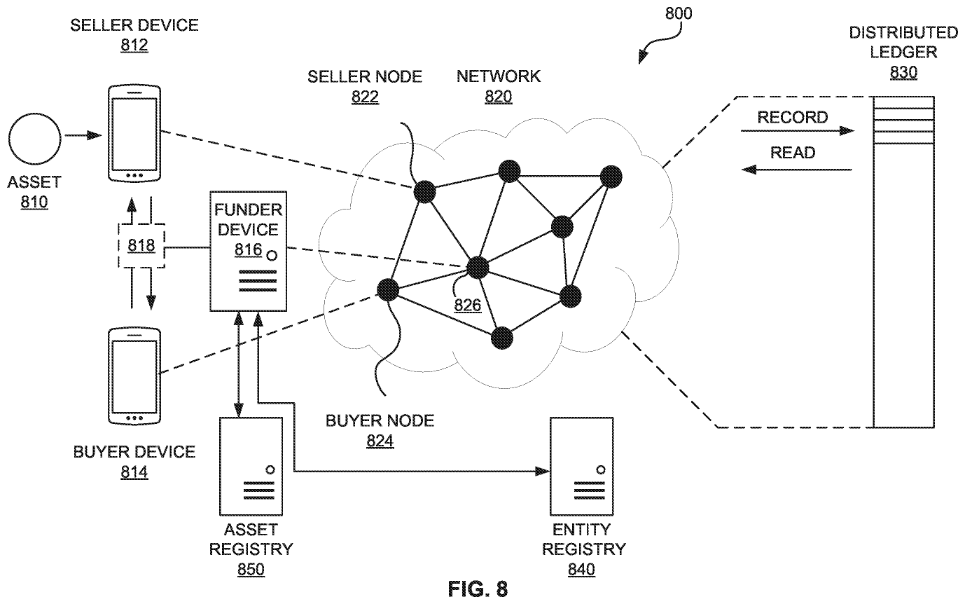

FIG. 8 is a schematic diagram of yet another example computer system 800 for facilitating transactions between transaction participant nodes connected over a peer-to-peer distributed ledger network. The system 800 is similar to the system 100 of FIG. 1, and thus includes an asset 810, seller device 812, buyer device 814, funder device 816, holding entity 818, network 820, seller node 822, buyer node 824, funder node 826, and distributed ledger 830. For further description of these elements, reference may be had to the description of the system 100 of FIG. 1.

In contrast to the system 100, the system 800 includes an off-ledger entity registry 840 and off-ledger asset registry 850 in communication with the funder device 816. The off-ledger entity registry 840 provides a secondary source of data to be compared against the entries on the distributed ledger 830 to verify the establishment, and the status, of holding entities like the holding entity 818. The off-ledger entity registry 840 may include, where the holding entity 818 is a corporation, a corporate registry or the like. The off-ledger asset registry 850 provides a secondary source of data to be compared against the entries on the distributed ledger 830 to verify title to assets like the asset 810. The off-ledger asset registry 850 may include, where the asset 810 is a real estate asset, a land titles registry or the like.

Thus, a method for facilitating transfer of the asset 810 may involve verifying title to the asset 810 before, during, or after the transaction. Such a verification step may reduce fraud and bring greater certainty to the legitimacy of assets transferred via the system 800. Further, a method for facilitating transfer of the asset 810 may involve verifying the identity and control of the holding entity 818 before, during, or after the transaction. Such a verification step may also reduce fraud and bring greater certainty to the legitimacy of assets transferred via the system 800.

Thus, it may be seen that a system can be provided for facilitating asset transfer which enables alternative modes of transacting and financing. The alternative modes of transacting and financing may be structured in a manner more desirable than conventional modes of transacting and financing for being more stable, secure, and flexible, or for avoiding the imposition of restrictive regulation.

The scope of the claims should not be limited by the above examples but should be given the broadest interpretation consistent with the description as a whole.

1. A computer system for facilitating transactions between transaction participant computing devices connected over a peer-to-peer distributed ledger network, the computer system comprising:
a buyer computing device to record, on a distributed ledger, an indication of a request from a buyer device to purchase an asset;
a seller computing device to record, on the distributed ledger, an indication of acceptance from a seller device to sell the asset in accordance with the request for an agreed price; and
a sponsor computing device, the sponsor computing device controlled by an operator of the sponsor computing device, the operator of the sponsor computing device to establish a holding entity through which ownership of the asset is transferred from an operator of the seller device to an operator of the buyer device through completion of a financing term in which the operator of the buyer device effects repayment of a loan price to the operator of the sponsor computing device, the loan price greater than the agreed price, the holding entity holding title to the asset throughout a duration of the financing term;
the sponsor computing device to record, on the distributed ledger, establishment of the holding entity and securitization of repayment of the loan price via a mortgage against the asset in favor of the operator of the sponsor computing device until completion of the financing term.

2. The system of claim 1, wherein:
the sponsor computing device is further to record, on the distributed ledger, securitization of repayment of the loan price via a pledge of control of the holding entity in favor of the operator of the sponsor computing device until completion of the financing term; and
one or more of the buyer computing device, seller computing device, and sponsor computing device are to:
record, on the distributed ledger, acquisition of title to the asset by the holding entity and acquisition of beneficial ownership of the asset by the operator of the sponsor computing device, for the agreed price;
record, on the distributed ledger, sale of the beneficial ownership of the asset from the operator of the sponsor computing device to the operator of the buyer device for the agreed price; and
record, on the distributed ledger, sale of control of the holding entity from the operator of the sponsor computing device to the operator of the buyer device for a control price, the control price and the agreed price together amounting to the loan price.

3. The system of claim 2, wherein the sponsor computing device is further to, when the operator of the buyer device fails to effect repayment of the loan price, record, on the distributed ledger, realization of the mortgage and the pledge by the operator of the sponsor computing device.

4. The system of claim 2, wherein the sponsor computing device is further to, when the operator of the buyer device completes repayment of the loan price, record, on the distributed ledger, release of the mortgage and the pledge by the operator of the sponsor computing device.

5. The system of claim 1, wherein:
the fund is further to record, on the distributed ledger, acquisition of title to the asset by the holding entity; and
one or more of the buyer computing device, seller computing device, and sponsor computing device are to:
record, on the distributed ledger, sale of control of the holding entity from the operator of the sponsor computing device to the operator of the buyer device for the loan price.

6. The system of claim 5, wherein the sponsor computing device is further to, when the operator of the buyer device fails to effect repayment of the loan price, record, on the distributed ledger, realization of the mortgage by the operator of the sponsor computing device.

7. The system of claim 1, further comprising an investor computing device to record, on the distributed ledger, provision of funds from an operator of an investor device to the operator of the sponsor computing device to finance the mortgage.

8. The system of claim 1, wherein one or more of the buyer device, seller device, and operator of sponsor computing device are to record establishment of the holding entity at an off-ledger corporate registry and to record transference of the asset at an off-ledger asset registry.

9. The system of claim 1, wherein the buyer device comprises a first mobile device and the seller device comprises a second mobile device.

10. A sponsor computing device connected over a peer-to-peer distributed ledger network to transaction participant computing devices, the sponsor computing device comprising:
a communication interface to communicate with a buyer computing device and a seller computing device over the peer-to-peer distributed ledger network, an operator of the seller computing device in acceptance to sell an asset to an operator of the buyer computing device for an agreed price;
a controller to:
record, on a distributed ledger:
establishment of a holding entity, by an operator of the sponsor computing device, through which ownership of the asset is to be effected through completion of a financing term for repayment of a loan price by the operator of the buyer computing device, the loan price greater than the agreed price, the holding entity holding title to the asset during the financing term; and
securitization of repayment of the loan price via a mortgage against the asset in favor of the operator of the sponsor computing device until completion of the financing term.

11. The sponsor computing device of claim 10, wherein the controller is further to:
record, on the distributed ledger, securitization of repayment of the loan price via a pledge of control of the holding entity in favor of the operator of the sponsor computing device until completion of the financing term;
record, on the distributed ledger, acquisition of title to the asset by the holding entity and acquisition of beneficial ownership of the asset by the operator of the sponsor computing device, for an agreed price;
record, on the distributed ledger, sale of the beneficial ownership of the asset from the operator of the sponsor computing device to the operator of the buyer computing device for the agreed price; and
record, on the distributed ledger, sale of control of the holding entity from the operator of the sponsor computing device to the operator of the buyer computing device for a control price, the control price and the agreed price together amounting to the loan price.

12. The sponsor computing device of claim 11, wherein the sponsor computing device is further to, when the operator of the buyer computing device fails to effect repayment of the loan price, record, on the distributed ledger, realization of the mortgage and the pledge by the operator of the sponsor computing device.

13. The sponsor computing device of claim 11, wherein the sponsor computing device is further to, when the operator of the buyer computing device completes repayment of the loan price, record, on the distributed ledger, release of the mortgage and the pledge by the operator of the sponsor computing device.

14. The sponsor computing device of claim 10, wherein sponsor computing device is further to record establishment of the holding entity at an off-ledger corporate registry and to record transference of the asset at an off-ledger asset registry.

15. The sponsor computing device of claim 10, wherein:
the fund is further to record, on the distributed ledger, acquisition of title to the asset by the holding entity; and
one or more of the buyer computing device, seller computing device, and sponsor computing device are to:
record, on the distributed ledger, sale of control of the holding entity from the operator of the sponsor computing device to the operator of the buyer computing device for the loan price.

16. The sponsor computing device of claim 15, wherein the sponsor computing device is further to, when the operator of the buyer device fails to effect repayment of the loan price, record, on the distributed ledger, realization of the mortgage by the operator of the sponsor computing device.

17. A non-transitory computer-readable medium comprising instructions executable by a controller to:
establish a holding entity through which ownership of an asset is transferred from an operator of a selling device to an operator of a buyer device through completion of a financing term for repayment of a loan price by the operator of the buyer device, wherein the asset to be purchased is indicated by the buyer device, wherein the loan price is the sum of a control price and an agreed price, wherein the control price comprises the price of selling control of the holding entity from the sponsor of the mortgage to the operator of the buyer device, wherein the agreed price comprises the price of acquiring title to the asset by the holding entity and acquiring beneficial ownership of the asset by the sponsor of the mortgage, wherein the holding entity holding title to the asset during the financial term; and
securitize repayment of the loan price via a mortgage against the asset in favor of the sponsor of the mortgage until completion of the financing term.

18. The non-transitory computer-readable medium of claim 17, the controller to further securitize the repayment of the loan price via a pledge of control of the holding entity until completion of the financing term.

19. The non-transitory computer-readable medium of claim 18, wherein when the operator of the buyer device fails to effect repayment of the loan price, realizing the mortgage and the pledge by the sponsor of the mortgage.

20. The non-transitory computer-readable medium of claim 18, wherein when the operator of the buyer device completes repayment of the loan price, releasing the mortgage and the pledge by the sponsor of the mortgage.

21. The non-transitory computer-readable medium of claim 17, the controller to further:
record acquisition of title to the asset by the holding entity; and
record sale of control of the holding entity to the operator of the buyer device for the loan price.

22. The non-transitory computer-readable medium of claim 21, wherein when the operator of the buyer device fails to effect repayment of the loan price, recording realization of the mortgage by the sponsor of the mortgage.

23. The non-transitory computer-readable medium of claim 17, the controller to further record establishment of the holding entity at a corporate registry and transference of the asset at an asset registry.
